(19) United States
(12) Patent Application Publication
(10) Pub. No.: US 2008/0271320 A1
(43) Pub. Date: Nov. 6, 2008

(54) Strawberry huller

(75) Inventors: Todd Brunner, Brooklyn, NY (US); Jim Best, Hewitt, NJ (US); Marco Perry, Brooklyn, NY (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 11/799,686

(22) Filed: May 2, 2007

(51) Int. Cl. A47J 25/00

(52) U.S. Cl. 30/113.1

(57) ABSTRACT

A hulling device for removing the stem and leaves on small fruits, such as strawberries, the device having an ergonomic handle and a tubular cutting member, is set forth herein. The cutting member is comprised of a cutting end and is securely attached to the handle at a shoulder which assists in preventing complete coring of the fruit. The tubular cutting member having a length which is less than the length of the handle also facilitates prevention of coring edible fruit flesh from the strawberry.

### TECHNICAL FIELD OF THE INVENTION

The present device relates to strawberry hullers. Particularly, the present device relates to a handheld strawberry huller for quickly and easily hulling such fruit without removing an excess of edible fruit flesh.

### BACKGROUND OF THE INVENTION

There are an almost uncountable number of desserts and dishes which call for the use of fresh fruit, such as strawberries. Typically, strawberries are bought fresh from the market, cleaned and then individually sliced for use. Strawberries are somewhat unique as a fruit, because unlike fruit such as apples and pears, strawberries do not have a seedy core to remove. And, unlike fruit such as oranges, kiwi and bananas, strawberries do not have a skin or peel to remove. Unfortunately, much like grapes and cherries, fresh strawberries do have a stem that requires removal before eating.

Strawberry stems can be removed from the strawberry in a variety of ways, including the use of fingers, or by using either a strawberry corer or a strawberry huller. The use of ones' fingers can be messy, slow and unsanitary. A paring knife may also be employed to remove the stem and core from a strawberry. This is also time consuming and can waste strawberry flesh.

A strawberry corer, as described in U.S. Pat. No. 4,949,459 to Noble, U.S. Pat. No. 5,092,043 to Shirkey, and U.S. Pat. No. 5,794,344 to Poulos et al., unnecessarily remove the entire core of the strawberry. The known hullers (also known in the art as a stem plucker) are tiny tong-like devices which, when squeezed by the user, are used to grab the strawberry stem securely and then pull it off. Similar to a pairing knife, the known hullers can be slow and may remove too much of the desired strawberry flesh.

There is disclosed herein an improved strawberry huller which avoids the disadvantages of prior devices while affording additional structural and operating advantages.

### SUMMARY OF THE INVENTION

A hulling device having an ergonomic handle and a tubular cutting member is set forth herein. The cutting member is comprised of a cutting end and is attached to the handle. The tubular cutting member has a length which is less than the length of the handle.

It is an aspect of the huller to provide a shoulder at the connection between the cutting end and handle, wherein the shoulder stops penetration of the food at the length of the cutting member.

It is an aspect of the present huller wherein the length of the tubular cutting member prevents the cutting member from cutting substantially through the strawberry. Preferably, the tubular cutting member is less than one and one-half inches (1½ inches) in length. Most preferably, the tubular cutting member is less than one inch in length.

It is another aspect of the present huller to provide an handle which sits comfortably in the user's hand. Preferably, the ergonomic handle is covered at least in part by a thermoplastic elastomer (TPE) material, such as SANTOPRENE.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of the present strawberry huller;

FIG. 2 is a cross-section of the embodiment of FIG. 1;

FIG. 3 is a front view of the embodiment shown in FIG. 1;

FIG. 4 is a side view of the embodiment shown in FIG. 1;

FIG. 5 is a top view of the embodiment shown in FIG. 1;

FIG. 6 is a bottom view of the embodiment shown in FIG. 1; and

FIG. 7 is a perspective view of the huller to be used on a small fruit.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

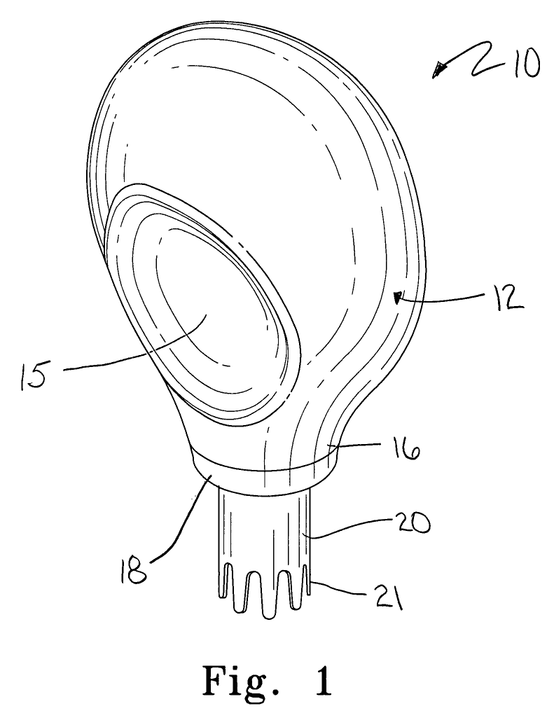

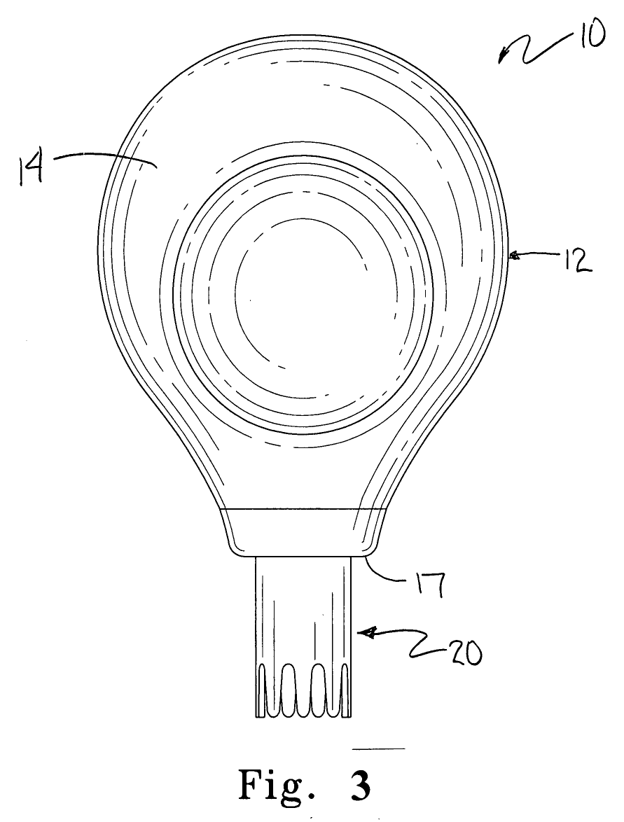

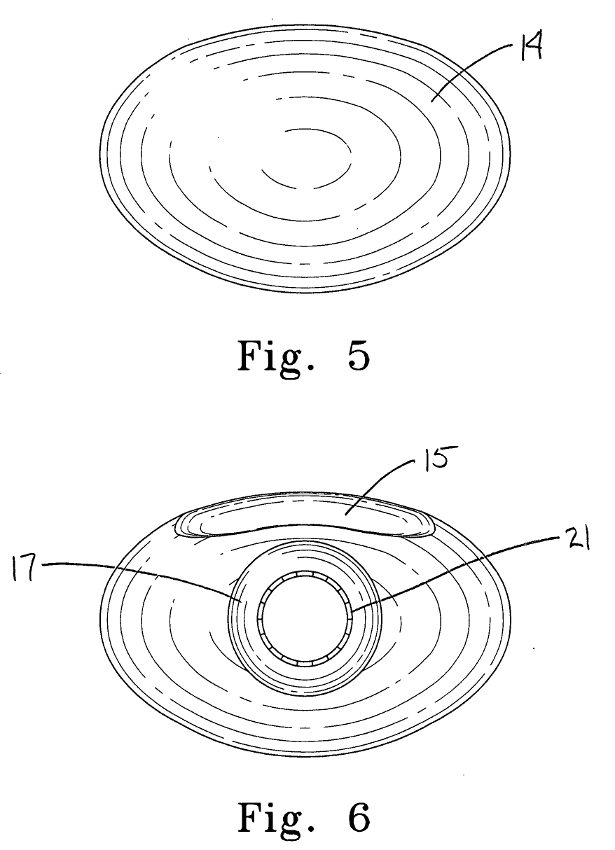

Referring to FIGS. 1-7, there is illustrated a strawberry huller, generally designated by the numeral 10. The huller 10 has an ergonomic handle 12 and a cutting member 20. The ergonomic handle 12 is preferably sized and contoured to fit comfortably within the hand of a user.

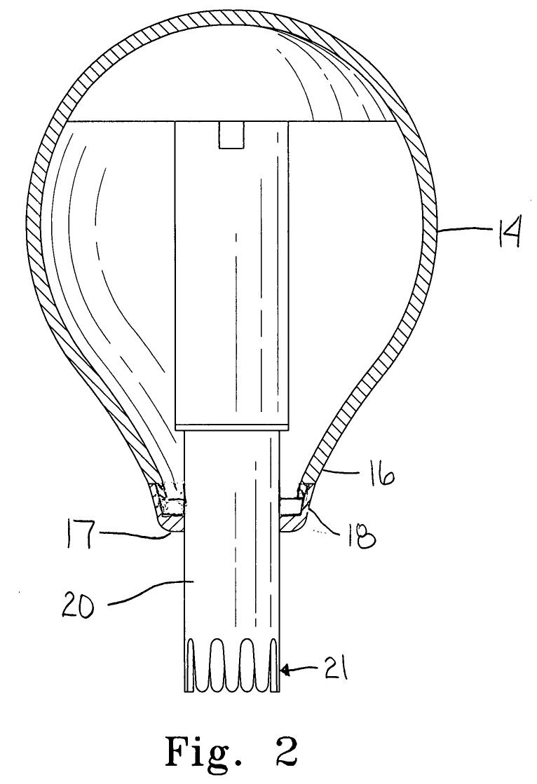

Accordingly, as shown in FIGS. 2, 3 and 5, the handle 12 has a substantially round and bulbous body 14 with a depressed area 15 on one side. The depressed area 15 provides a suitable spot for positioning of the user's thumb during operation. The body 14 of the handle 12 is preferably molded from a rigid plastic material. However, to increase the comfort of holding the huller 10, a layer of resilient material, such as a thermoplastic elastomer (TPE), can be coated onto at least a portion, if not the entire body 14. SANTOPRENE® is a preferred material for such cushioning.

As shown in FIG. 2, the handle 12 includes an integral taper 16 extending from the body 14 and leading into a shoulder 17. In the preferred embodiment, a cap 18 mounts to the body 14 at the taper to form the shoulder 17. The cap 18 is a metal ringed component which secures to the handle 12. The cap 18 protects the resilient layer from being easily peeled from the body, as well as assists in securing the cutting member 20 to the handle 12.

Alternatively, the shoulder 17 can be made of the same materials as the body 14 of handle 12, including resilient material, if desired.

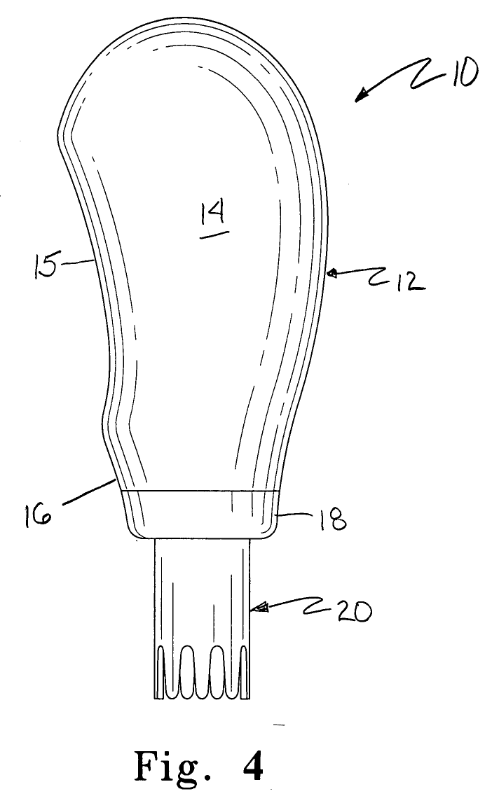

With reference to FIGS. 4 and 6, the cutting member 20 can be more readily understood. The cutting member 20 is preferably a cylindrical metal component secured at one end within the molded body 14 of handle 12 and extending outward (as measured from the shoulder 17) no more than 1-½ inches (about 3.7 cm). Preferably, the cutting member 20 is stainless steel and extends no more than one-half inch (about 1.3 cm). The other end of cutting member 20 includes a crenellated cutting edge 21. However, the cutting edge 21 may be of any configuration which is suitable for cutting into the flesh of a fruit, such as a strawberry.

In final construction, the huller is comprised of materials which are readily washable, and preferably dishwasher safe. The connections between the handle 12, cap 18 and cutting member 20 should be sufficiently sealed to prevent germ and water penetration.

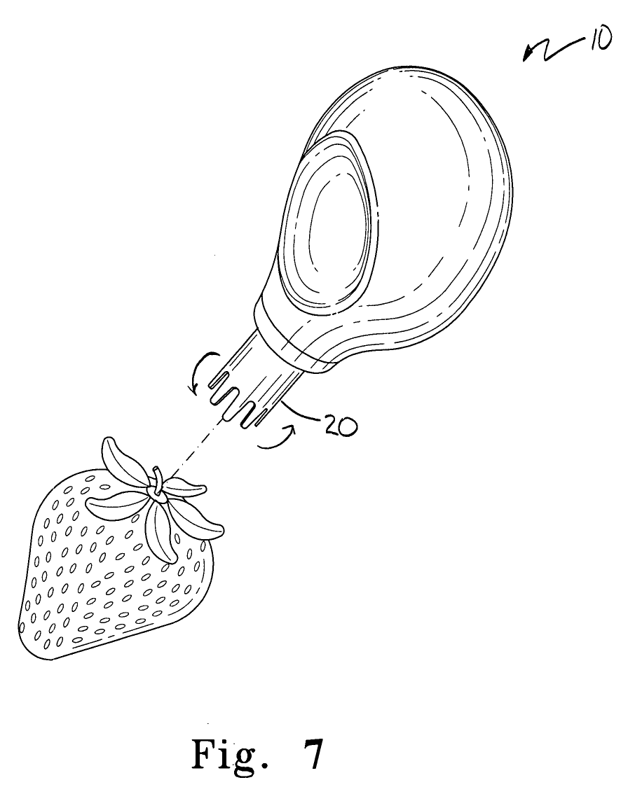

In use, as illustrated in FIG. 7, the huller 10 is first positioned to penetrate a strawberry by placing the cutting member 20 about the stem of the fruit. A small amount of force on the huller 10 handle 12 toward the strawberry, with or without a twisting motion, will drive the cutting edge 21 of the cutting member 20 into the fruit. The cutting member 20 will penetrate the berry until the force is stopped or until the shoulder 17 of the handle 12 abuts the fruit. Retraction of the cutting member 20, with or without twisting, will withdraw the strawberry stem, the leaves surrounding the stem, and a small portion of the strawberry flesh where the stem is attached.

The shoulder 17 and the shortness of the cutting member 20 cooperate to prevent complete penetration of the fruit by huller 10. These features avoid a complete coring of the fruit, a process which unnecessarily removes edible flesh.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A hulling device comprising:
an ergonomic handle, and
a tubular cutting member having a cutting end and being attached to the handle, wherein the tubular cutting member has a length less than a length of the handle.

2. The hulling device of claim 1, wherein the length of the tubular cutting member prevents the cutting member from cutting substantially through a food.

3. The hulling device of claim 2, wherein the tubular cutting member is less than one and one-half (1½) inches in length.

4. The hulling device of claim 3, wherein the tubular cutting member is less than one inch in length.

5. The hulling device of claim 1, wherein the tubular cutting member is fixed to the handle.

6. The hulling device of claim 1, wherein the handle is covered at least in part by a thermoplastic elastomer (TPE) material.

7. The hulling device of claim 6, wherein the TPE material comprises SANTOPRENE.

8. The hulling device of claim 1, wherein the cutting member is attached to the handle at a shoulder, wherein the shoulder stops penetration of the food at the length of the cutting member.

9. The hulling device of claim 8, wherein the tubular cutting member is less than one and one-half (1½) inches in length.

10. The hulling device of claim 9, wherein the tubular cutting member is less than one inch in length.

11. A huller for small fruit comprising:
an ergonomic handle, and
a tubular cutting member attached to the handle and having a cutting end for cutting into the small fruit to a depth, a fixed stop for halting the depth of the cutting end, wherein the depth is less than a distance through the fruit.

12. A huller for small fruit as described in claim 11, wherein the fixed stop comprises a shoulder at the attachment between the cutting member and the handle.

13. A huller for small fruit as described in claim 12, wherein the length of the tubular cutting member prevents the cutting member from cutting substantially through the small fruit.

14. The huller for small fruit as described in claim 13, wherein the tubular cutting member is less than one and one-half inches (1½) inches in length.

15. The huller for small fruit as described in claim 14, wherein the tubular cutting member is less than one inch in length.

16. The huller for small fruit as described in claim 11, wherein the handle is covered at least in part by a thermoplastic elastomer (TPE) material.

17. The huller for small fruit as described in claim 16, wherein the TPE material comprises SANTOPRENE.

18. The huller for small fruit as described in claim 11, wherein the ergonomic handle comprises a depressed area for better grasping of the huller.
